(19) United States
(12) Patent Application Publication
(10) Pub. No.: US 2018/0341668 A1
(43) Pub. Date: Nov. 29, 2018

(54) SYSTEM AND METHOD FOR GENERATING VARIABLE IMPORTANCE FACTORS IN SPECIALTY PROPERTY DATA

(71) Applicant: A Place for Mom, Inc., Seattle, WA (US)

(72) Inventor: Benjamin Dalton Oliver Hanowell, Seattle, WA (US)

(21) Appl. No.: 15/986,494

(22) Filed: May 22, 2018

Related U.S. Application Data
(60) Provisional application No. 62/511,278, filed on May 25, 2017.

(51) Int. Cl. G06F 17/30; G06Q 50/16

(52) U.S. Cl. CPC G06F 17/30321; G06Q 50/16; G06F 17/30598; G06F 17/3087

(57) ABSTRACT

Systems, apparatuses, and methods for enabling a user to collect, assemble, manipulate, and utilize data corresponding to one or more specific markets about specialty properties, such as assisted living, long-term care facilities, and the like. Several factors will affect a specific market. Collecting this data and assigning relative values to the data leads to an ever-changing set of indices that is continuously updated through a machine-learning algorithm by which index data may be gleaned at any given moment in time for any specific region. These factors may exhibit variable importance across various regions and demographics. By identifying and determining the impact of these variable importance factors, future costs or future demand may be gleaned to allow a specialty property manager to more insightfully plan for acquisition and expansion based on gleaned statistics from actual data in the ebb and flow of specialty property use.

### CLAIM TO PRIORITY APPLICATION

This application claims the benefit of U.S. Provisional Application No. 62/511,278 entitled “SYSTEM AND METHOD FOR GENERATING VARIABLE IMPORTANCE FACTORS IN SPECIALTY PROPERTY DATA,” filed May 25, 2017, which is incorporated by reference in its entirety herein for all purposes.

### CROSS-REFERENCE TO RELATED APPLICATIONS

This application is cross-related to the following U.S. patent applications: (Attorney Docket No 126129-001003) U.S. patent application Ser. No. ______, entitled “System and Method for Generating Specialty Property Demand Index,” filed May ______, 2018; (Attorney Docket No 126129-001103) U.S. patent application Ser. No. ______, entitled “System and Method for Generating Specialty Property Cost Index,” filed May ______, 2018; (Attorney Docket No 126129-001303) U.S. patent application Ser. No. ______, entitled “System and Method for Generating Cost Estimates for Specialty Property,” filed May ______, 2018; (Attorney Docket No 126129-001603) U.S. patent application Ser. No. ______, entitled “System and Method for Generating Same Property Cost Growth Estimate in Changing Inventory of Specialty Property,” filed May ______, 2018; (Attorney Docket No 126129-001803) U.S. patent application Ser. No. ______, entitled “System and Method for Generating Indexed Specialty Property Data Influenced by Geographic, Econometric, and Demographic Data,” filed May ______, 2018; (Attorney Docket No 126129-001903) U.S. patent application Ser. No. ______, entitled “System and Method for Identifying Outlier Data in Indexed Specialty Property Data,” filed May ______, 2018; (Attorney Docket No 126129-002003) U.S. patent application Ser. No. ______, entitled “System and Method for Generating Indexed Specialty Property Data From Transactional Move-In Data,” filed May ______, 2018. Each of these are incorporated by reference in their entireties herein for all purposes.

### BACKGROUND

Specialty property, such as senior living and assisted care facilities, are growing in demand in the United States and other countries due to a rapidly aging population. As modern medical breakthroughs allow for longer and more actives lives, the demand for senior living facilities continues to rise. Predicting the consumer cost and demand for specialty property can be a difficult task with disparate information available across disparate social, geographic, econometric and demographic strata.

Further, existing methods for predicting cost and demand of senior living and similar specialty properties are based on surveys of property managers rather than consumer transactions. Properties may respond to surveys with list prices that do not reflect actual costs because they do not account for one-off move-in concessions or consumer-level variation in the cost of senior care. Furthermore, surveying at the property level prevents detailed inference about the distribution of costs in addition to point estimates. This application presents an invention that overcomes the limitations of existing methods by estimating specialty property costs based on consumer-level transaction data from a specialty property referral service.

### BRIEF DESCRIPTION OF DRAWINGS

The drawings described herein are for illustrative purposes only of selected embodiments and not all possible implementations, and are not intended to limit the scope of the present disclosure.

FIG. 1 is a block diagram of a networked computing environment for facilitating data collection, analysis and consumption in a specialty property analytics and machine system according to an embodiment of the present disclosure;

FIG. 2 is an exemplary computing environment that is a suitable representation of any computing device that is part of the system of FIG. 1 according to an embodiment of the present disclosure;

FIG. 3 is a block diagram of the server of FIG. 1 according to an embodiment of the subject matter disclosed herein;

FIG. 4 is a method flow chart for cost index data generation using the system of FIG. 1 according to an embodiment of the subject matter disclosed herein;

FIG. 5 is a method flow chart for determining cost estimate data for specialty property according to an embodiment of the subject matter disclosed herein; and

FIG. 6 is a method flow chart for implementing detection and use of variable importance factors for specialty property according to an embodiment of the subject matter disclosed herein.

Corresponding reference numerals indicate corresponding parts throughout the several views of the drawings.

### DETAILED DESCRIPTION

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Embodiments will be described more fully hereinafter with reference to the accompanying drawings, which form a part hereof, and which show, by way of illustration, exemplary embodiments by which the systems and methods described herein may be practiced. The systems and methods may, however, be embodied in many different forms and should not be construed as limited to the embodiments set forth herein; rather, these embodiments are provided so that this disclosure will satisfy the statutory requirements and convey the scope of the subject matter to those skilled in the art.

Among other things, the present subject matter may be embodied in whole or in part as a system, as one or more methods, or as one or more devices. Embodiments may take the form of a hardware-implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, or the like) that is part of a client device, server, network element, or other form of computing device/platform and that is programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

Prior to discussing specific details of the embodiments described herein, a brief overview of the subject matter is presented. Generally, one or more embodiments are directed to systems, apparatuses, and methods for enabling a user to collect, assemble, manipulate, and utilize data corresponding to one or more specific markets about specialty properties, such as assisted living, long-term care facilities, and the like. Several factors will affect a specific market and the ebb and flow of regional demand, regional cost, regional demographics, and regional econometrics. Further, intra-regional and extra-regional data may also reflect the behavior of individuals in a market based on additional factors. Collecting this data and assigning relative values to the data based on follow-on activities, such as actual inquiries into property, lead generation for specific properties and move-in data for specific properties leads to an ever-changing set of indices that is continuously updated through a machine-learning algorithm by which index data may be gleaned at any given moment in time for any specific region.

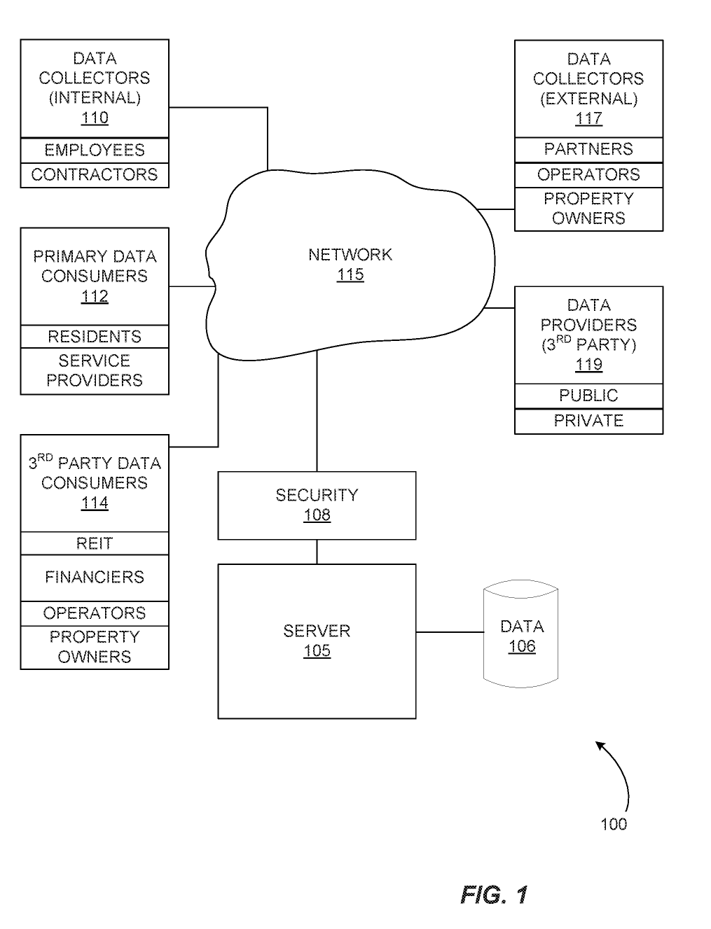

To this end, several specific factors may influence these indices more than others. These factors may exhibit variable importance across varies regions and demographics. By identifying and determining the impact of these variable importance factors on future costs or future demand allow a specialty property manager to more insightfully plan for acquisition and expansion based on gleaned statistics from actual data in the ebb and flow of specialty property use. These and other aspects of the specific embodiments are discussed below with respect to FIGS. 1-5.

FIG. 1 is a block diagram of a networked computing environment 100 for facilitating data collection, analysis, and consumption in a specialty property analytics and machine system according to an embodiment of the present disclosure. The environment 100 includes a number of different computing devices that may each be coupled to a computer network 115. The computer network 115 may be the internet, and internal LAN or WAN or any combination of known computer network architectures. The environment 100 may include a server computer 105 having several internal computing modules and components configured with computer-executable instructions for facilitating the collection, analysis, assembly, manipulation, storing, and reporting of data about specialty property costs and demand. The server 105 may store the data and executable instructions in a database or memory 106. The server 105 may also be behind a security firewall 108 that may require username and password credentials for access to the data and computer-executable instructions in the memory 106.

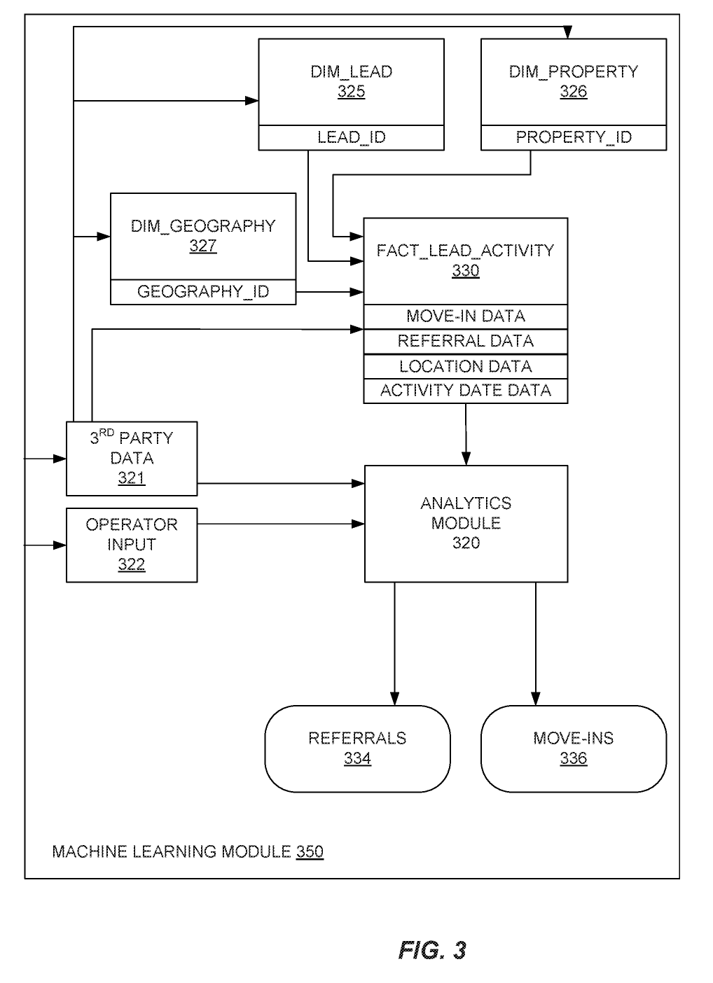

The environment 100 may further include several additional computing entities for data collection, provision, and consumption. These entities include internal data collectors 110, such as employee computing devices and contractor computing devices. Internal data collectors 110 may typically be associated with a company or business entity that administers the server computer 105. As such, internal data collectors 110 may also be located behind the firewall 108 with direct access to the server computer (without using any external network 115). Internal data collectors may collect and assimilate data from various sources of data regarding specialty properties. Such data collected may include data from potential resident inquiries, leads data from advisors working with/for the business entity, and move-in data from property owners and operators. Many other examples of collected data exist but are discussed further below with respect to additional embodiments. The aspects of the specific data collected by internal data collectors 110 is described below with respect to FIG. 3A-B.

The environment 100 may further include external data collectors 117, such as partners, operators and property owners. Internal data collectors 110 may typically be third party businesses that have a business relationship with the company or business entity that administers the server computer 105. External data collectors 110 may typically be located outside of the firewall 108 without direct access to the server computer such that credentials are used through the external network 115. Such data collected may include data from potential resident inquiries, leads data from advisors working with/for the business entity, and move-in data from property owners and operators. Many other examples of collected data exist but are discussed further below with respect to additional embodiments. The aspects of the specific data collected by external data collectors 117 is also described below with respect to FIG. 3.

The environment 100 may further include data from third-party data providers 119, that includes private entities such as WalkScore, Redfin, or Zillow data about walkability and living costs. In addition, the environment may include public data sources such as the American Community Survey (ACS) and US Department of Housing and Urban Development (HUD). These third-party data providers may provide geographic, econometric, and demographic data to further lend insights into the collected data about potential resident inquiries, leads, and move-in data. Many other examples of third-party data exist but are discussed further below with respect to additional embodiments.

The environment 100 may further include primary data consumers 112, such as existing and potential residents as well as service providers. The environment 100 may further include, and third-party data consumers 114, such as Real-Estate Investment Trusts (REITs), financiers, third-party operators, and third-party property owners. These primary data consumers 112 and third-party data consumers 114 may use the assimilated data in the database collected from data collectors and third parties to glean information about one or more specialty property markets. Such data consumed may include the very data from potential resident inquiries, leads data and move-in data. Many other examples of consumed data exist but are discussed further below with respect to additional embodiments as well as discussed in related patent applications.

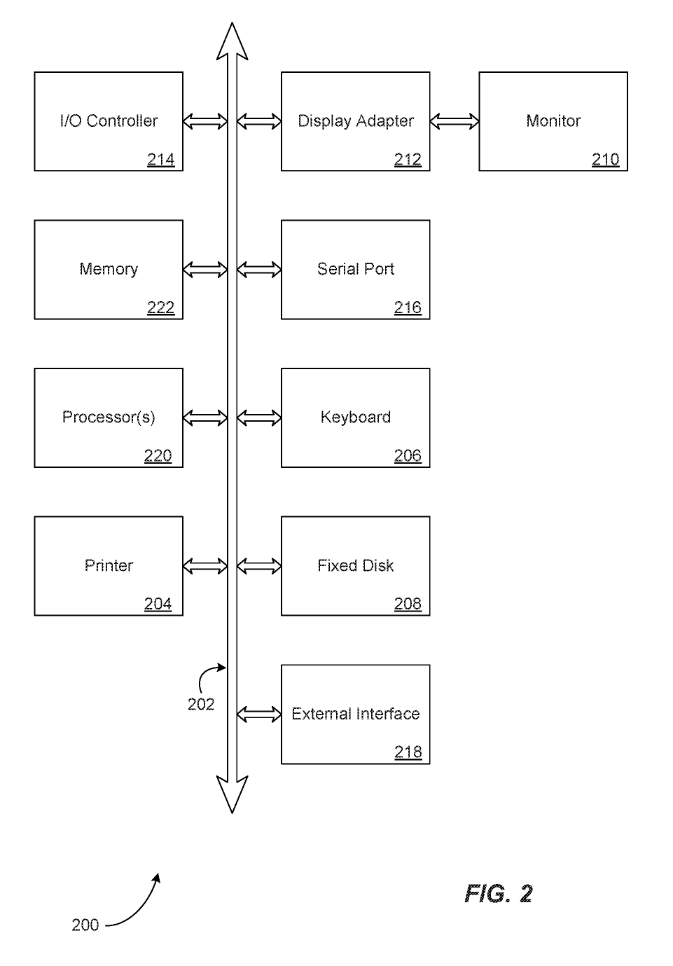

Collectively, the data collected and consumed may be stored in the database 106 and manipulated in various ways described below by the server computer 105. Prior to discussing aspects of the operation and data collection and consumption as well as eth cultivation of the database, a brief description of any one of the computing devices discussed above is provided with respect to FIG. 2.

FIG. 2 is a diagram illustrating elements or components that may be present in a computer device or system configured to implement a method, process, function, or operation in accordance with an embodiment. In accordance with one or more embodiments, the system, apparatus, methods, processes, functions, and/or operations for enabling efficient configuration and presentation of a user interface to a user may be wholly or partially implemented in the form of a set of instructions executed by one or more programmed computer processors such as a master control unit (MCU), central processing unit (CPU), or microprocessor. Such processors may be incorporated in an apparatus, server, client or other computing or data processing device operated by, or in communication with, other components of the system. Such computing devices may further be one or more of the group including: a desktop computer, as server computer, a laptop computer, a handheld computer, a tablet computer, a smart phone, a personal data assistant, and a rack computing device.

As an example, FIG. 2 is a diagram illustrating elements or components that may be present in a computer device or system 200 configured to implement a method, process, function, or operation in accordance with an embodiment. The subsystems shown in FIG. 2 are interconnected via a system bus 202. Additional subsystems include a printer 204, a keyboard 206, a fixed disk 208, and a monitor 210, which is coupled to a display adapter 212. Peripherals and input/output (I/O) devices, which couple to an I/O controller 214, can be connected to the computer system by any number of means known in the art, such as a serial port 216. For example, the serial port 216 or an external interface 218 can be utilized to connect the computer device 200 to further devices and/or systems not shown in FIG. 2 including a wide area network such as the Internet, a mouse input device, and/or a scanner. The interconnection via the system bus 202 allows one or more processors 220 to communicate with each subsystem and to control the execution of instructions that may be stored in a system memory 222 and/or the fixed disk 208, as well as the exchange of information between subsystems. The system memory 222 and/or the fixed disk 208 may embody a tangible computer-readable medium.

It should be understood that the present disclosure as described above can be implemented in the form of control logic using computer software in a modular or integrated manner. Based on the disclosure and teachings provided herein, a person of ordinary skill in the art will know and appreciate other ways and/or methods to implement the present disclosure using hardware and a combination of hardware and software.

Any of the software components, processes or functions described in this application may be implemented as software code to be executed by a processor using any suitable computer language such as, for example, R, Java, JavaScript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

FIG. 3 is a block diagram of a machine-learning module 350 of the server 105 of FIG. 1 according to an embodiment of the subject matter disclosed herein. The machine-learning module 350 may include various programmatic modules and execution blocks for accomplishing various tasks and computations with the context of the system and methods discussed herein. As discussed above, this may be accomplished through the execution of computer-executable instructions stored on a non-transitory computer readable medium. To this end, the various modules and execution blocks are described next.

The machine-learning module 350 may include lists of data delineated by various identifications that are indicative of the type and nature of the information stored in the ordered lists. At the outset, these lists, in this embodiment, include a first list of lead data called DIM_LEAD 325. A lead includes data about an individual who is interested in acquiring rights and services at a specialty property and each record in DIM_LEAD 325 may be identified by a LEAD_ID. In this embodiment, the rights and services may include rents and personal care services at a senior living facility. In other embodiments, the specialty property is not necessarily a senior care facility or senior housing. The LEAD_ID may also include specific geographic data about a preferred location of a specialty property. The data that populates this list may be received at the machine-learning module 350 via a data collection module 321 that facilitates communications from various data collectors and third-party data providers as discussed with respect to FIG. 1. The information in DIM_LEAD 325 as described here may be collected chiefly by Senior Living Advisors, but could also be collected by third-party contractors (see data collectors 110 of FIG. 1).

Another list of data includes data about various properties in the pool of available or used specialty properties and this list is called DIM_PROPERY 326. The records in this list may include data about services provided at each property as well as cost data, availability, and specific location. DIM_PROPERY records may also include a history of property attributes over time for each PROPERTY_ID, so that leads can be matched to the property with each respective leads attributes. Records in DIM_PROPERY 326 are identified by a unique identifier called PROPERTY_ID. The data that populates this list may be received at the machine-learning module 350 via a data collection module 321 that facilitates communications from various data collectors and third-party data providers as discussed with respect to FIG. 1. DIM_PROPERTY 326 may be typically obtained from from partners, operators, and property owners (117 of FIG. 1), but additional information about the property (such as its age, number of units of a given unit type, recent renovation, etc.) may come from 3rd party private or public sources (119 of FIG. 1).

Another list of data includes data about various geographic locations in the pool of available or used specialty properties and this list is called DIM_GEOGRAPHY 327. The records in DIM_GEOGRAPHY 327 may include data about the geographic locations of all properties such as ZIP code, county, city, metropolitan area, state, and region. The records here may also include data about weather associated with various geographic location along with time and season factors. For example, one could collect data about time-stamped weather event to examine the impact of weather on the cost index. Records in this list are identified by a unique identifier called GEOGRAPHY_ID. The data that populates this list may be received at the machine-learning module 350 via a data collection module 321 that facilitates communications from various data collectors and third-party data providers as discussed with respect to FIG. 1. DIM_GEOGRAPHY 327 is collected from addresses of the properties, which are provided by partners, property owners, and operators (117 of FIG. 1), and addresses may be geotagged using public and private 3rd party sources (119 of FIG. 1) to acquire ZIP, county, city, metro, state, and region data.

All data from these various lists of data may be updated from time-to-time as various events occur or new data is collected or provided by various data collectors and third-party data providers via data collection module 321. As events takes place, a new conglomerate list, FACT_LEAD_ACTIVITY 330, may be initiated and populated with various events that occur along with associated relevant data from the lists. Records in FACT_LEAD_ACTIVITY 330 include data with regard to lead events and move-in events. A lead event is defined as the event in which an advisor refers a specific property to a potential user of services. A move-in event is defined as an event in which a user of services moves into a recommended property from a lead. As such, the records will also include specific data about the dates of the activity underlying the event as well as specific data about the recommended property (e.g., cost, location, region, demographics of the area) and the user (or potential user) of services (e.g., demographics, budget, services desired).

As mentioned, all data from these various lists of data may be updated from time-to-time as various events occur or new data is collected or provided by various data collectors and third-party data providers via data collection module 321. When an action takes place, such as a referral of a property to a lead or a lead moving in to a referred property, an activity record may be created in the list FACT_LEAD_ACTIVITY 330. This information may include data drawn from the initial three lists discussed above when a specific action takes place. Thus, each record will include a LEAD_ID, a PROPERTY_ID, and a GEOGRAPHY_ID that may be indexed with additional data such as activity type (e.g., referral or move-in) and activity date. For example, a new inquiry may be made, a new lead may be generated, a new property may become part of the property pool, geographic data may be updated as ZIP codes or city/county lines shift, and the like. Further, collected data could be used to update or populate DIM_PROPERY 326, DIM_LEAD 325, DIM_GEOGRAPHY 327 and FACT_LEAD_ACTIVITY 330 in that collected data about economics, demography, and geography (including weather) may be assimilated in any of the lists discussed above.

All data in FACT_LEAD_ACTIVITY 330 may be used by an analytics module 320 to generate several manners of data for use in the system. An operator may enter various analytical constraints and parameters using the operator input 322. The analytics module 320 may be manipulated such operator input to yield a desired analysis of the records stored in FACT_LEAD_ACTIVITY 330. Generally speaking, the data that may be assembled from the FACT_LEAD_ACTIVITY list 330 includes indexed referrals data 334 and indexed move-ins data 336. Such assembled data may be used to generate various cost and demand indexes and probabilities for a specialty property market across the several geographic, economic, and demographic categories. This useful indexed data across the operator desired constraints and parameters may then be communicated to other computing devices via communications module 340.

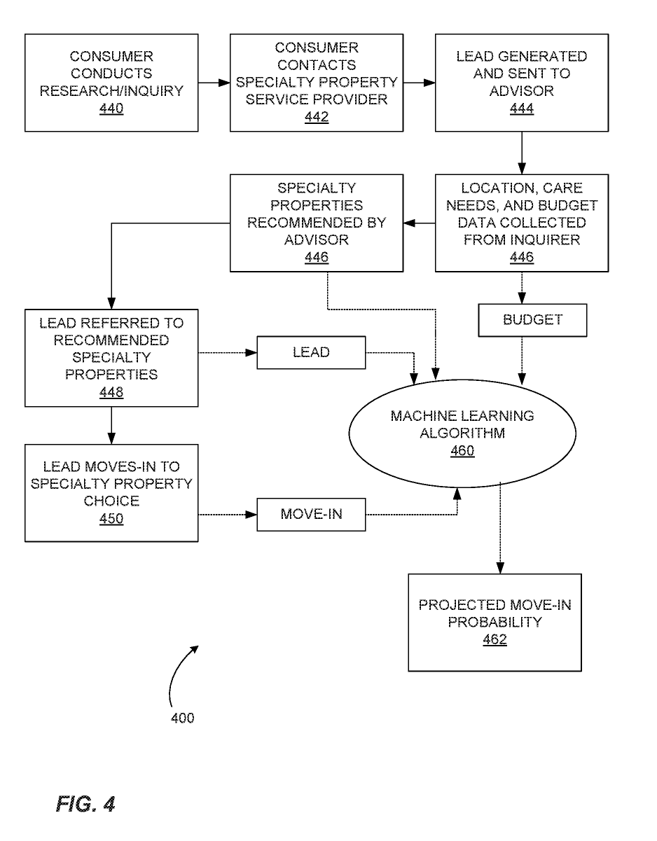

FIG. 4 is a method flow chart for cost index data generation using the system of FIG. 1 according to an embodiment of the subject matter disclosed herein. The method may begin when a prospective consumer initially conducts research and chooses to engage with a service provider for specialty properties that may be available at step 440. Such engagement may occur at step 442 through use of a user computer in sending a communication to an organization facilitating services for specialty properties. Once contact is made, a “lead” is generated wherein an advisor may become involved to facilitate a data collection process at step 444. The advisor may be an employee of the service-facilitation company or may be a third-party entity conducting data collection and lead follow-up on behalf of the facilitation company.

Regardless of the entity conducting the data collection, the event of the inquiry is converted into an indexed record at step 446 that includes various attributes about the inquiry, such as the inquirer's desired budget, desired service level or care needs, desired location, age, time-horizon and the like. Based on the provided data, the advisor may recommend a series of potential properties to the lead at step 447. Some of this initially collected data, such as budget data, may be sent to a machine-learning algorithm 150 at the time the data is collected. This data may be used to populate and/or update DIM_LEAD 325 as discussed above with respect to FIG. 3.

As various properties are recommended at step 448, each recommendation generates a “Lead Referral” (which is a tracked activity in FACT_LEAD_ACTIVITY 330) that includes sending lead data to the machine-learning algorithm 150. Further yet, as various leads actually move in to a recommended property at step 450, each move-in generates a “Move-In” event (which is also a tracked activity FACT_LEAD_ACTIVITY 330) that includes sending move-in data to the machine-learning algorithm 150. With all this indexed data being input to the machine-learning algorithm 150, analytics can be used to determine future cost for various property types in the form of projected cost growth probability at step 462. Put another way, a specialty property cost index may be generated based on all past and current data collected through the method of FIG. 4. As this cost index data is in an indexed form, various probabilities may be drawn out for subsets of the data as well. Such a subset cost probability may include a cost for properties in a specific geographic region, a cost for a specific type if property, a cost for properties within a specific budget, and the like. That is, the cost index, together with the analytical module of the machine-learning algorithm 350 may predict a vast number of probabilities based on current and historical data.

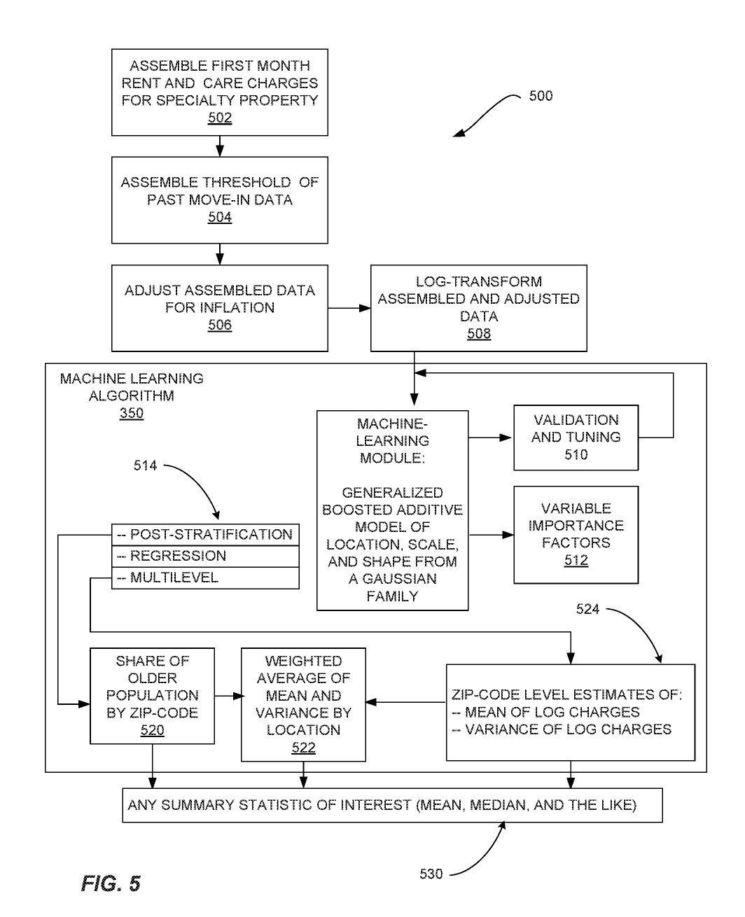

FIG. 5 is a method flow chart 500 for determining cost estimate data for specialty property according to an embodiment of the subject matter disclosed herein. Projecting future costs and growth of costs can be difficult in disparate markets across various geographies, economies, and demographics. Such estimation is further exacerbated by changing inventory within specialty property markets. Various methods are discussed herein for generating costs estimate data and the like from cost index data.

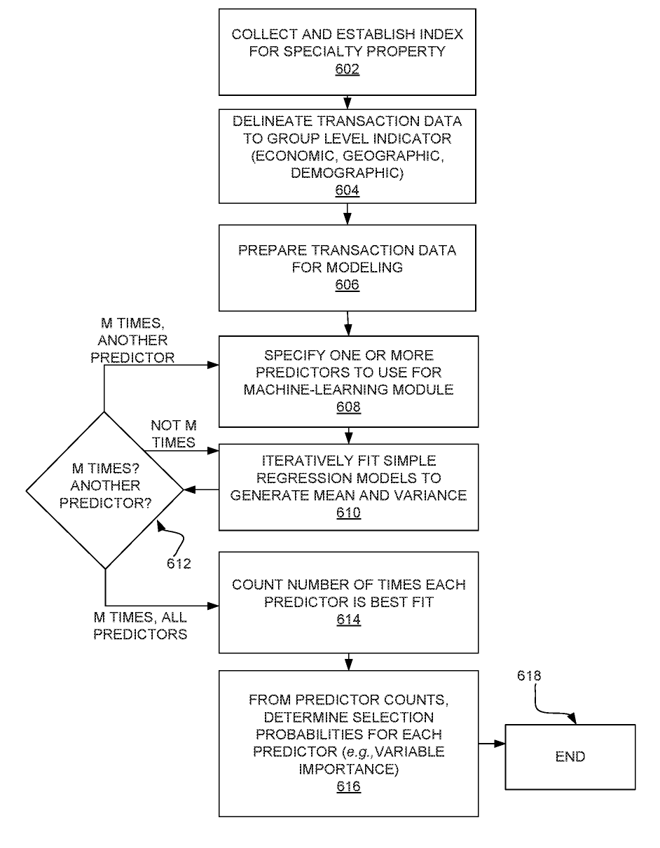

In an embodiment, the method may begin, at step 502, by assembling first-month rent and care charges across multiple care types, geographies, economies, and demographics as discussed above with respect to FIGS. 3 and 4. In order to provide meaningful estimation data, a threshold of past move-in data (e.g., actual transactions) may need to be satisfied at step 504. If such a threshold is met, past transaction data may also be adjusted for inflation prior to performing a logarithmic transform on the assembled cost index data at step 506. With inflation-adjusted data in a log-transform format (log-transform occurs at step 508), a machine-learning algorithm 350 may be invoked to draw statistical inferences from the assembled cost index data. Such a machine-learning algorithm 350 may be embodied in a computing module that is a generalized boosted additive model of location, scale and shape (GAMLSS) with a Gaussian family specification for the likelihood. The GAMLSS model estimates all of parameters of the distribution of costs conditional on the predictors (i.e., location, care type, etc.). In some embodiments, reiterative validation and tuning may be performed through training cycles and/or outlier data culling using the step loop function 510. In other embodiments, variable importance factors 512 may be gleaned from the assembled data and used to influence the building and maintenance of the index. These variable importance factors are discussed below with respect to FIG. 6.

The machine-learning algorithm 350 comprises multi-level, regression, and post-stratification aspects 514 (sometimes called MRP or “MisterP”) that will yield a number of different usable data sets that can then be part of a process for generating cost estimates and the like. The multi-level aspect of MRP refers to the fact that the model for cost estimates takes advantage of the hierarchical nesting of first-month rent and care charge data into ZIP codes, cities, counties, metropolitan areas, states, regions, and other nested groupings. The regression aspect of MRP refers to the fact that the cost estimates are modeled using a regression method (i.e., the GAMLSS described above). The post-stratification aspect of MRP refers to the fact that cost estimates from the GAMLSS are weighted by an estimate of the proportion of likely specialty property consumers who reside in a particular location (e.g., a county) that live in a more granular geographic unit (e.g., a ZIP code or more accurately a ZIP-code tabulation area) within that county. The overall assembled cost index data may be culled to produce interim data sets for use with generating any number of summary statistic as described below in step 530. Once such interim data set may be a distribution (e.g., share) of specialty property eligible tenants (e.g., an older population) is subset 520. Another interim data set 522 is a weighted average of mean and variance costs as distributed by location. Yet another interim data set includes zip-code level estimates at step 524 that may include both a mean of log charges and a variance of log charges.

Collectively, this subset data and the post-stratified estimates of the distributional parameters for a particular location and type(s) of care may be used to produce any summary statistic of interest for specialty property costs in that location and for that/those care type(s) at step 530. For example, one generated summary statistic may be a mean cost estimate for a specific location for a specific care-type. Another example may be generated summary statistic for median cost of a metropolitan area across all care-types. Yet another example is the 95 percent prediction interval for costs in a metropolitan area for a particular care type. Thus, a specific cost-growth estimate may be generated for any cross-section from the various input parameters available across any future time period.

FIG. 6 is a method flow chart for implementing determination and use of variable importance factors for specialty property according to an embodiment of the subject matter disclosed herein. With the many possible permutations of the data that can be assembled and gleaned, the initial index data may be based on (e.g., influenced by) several different factors across one or more categories of data. These factors are referred to herein as variable importance factors and comprise detectable influences on the assembly of index data or the culling and gleaning and data within an index. A user may determine an overall weighted effect of various variable importance factors to a specific index that may be used to set future prices tailored toward or away from a specific category or factor based on determined weightings of importance factors. A user may further adjust the level of influence (e.g., a weighting) any specific factor or category has upon an assembled index.

Generally speaking, these factors and categories may associated with and determined within geographic data sets, econometric data sets, and demographic data sets. As previously discussed, geographic data may include data arranged by ZIP code, city, county, state, metro area, regional area (e.g., Western US, Midwest, and the like), and country. Geographic data may also include non-location based factors such as weather, walkability, neighborhood appeal, and the like. Econometric data may be inflation rate, mean income data, median income data, consumer price index data, and the like. Demographic data may include data about individuals such as household income, age, ethnicity, religion, gender, marital status, and the like. All of these variable importance factors may be gleaned from an initial index of specialty property data (e.g., a cost index or a demand index) or subsequently gleaned from a modified or updated index.

Turning to FIG. 6, a user may establish index at step 602 using one or more systems and methods described above with respect to FIGS. 1-5 (specifically FIG. 3) Any index (e.g., a cost index, a demand index, and the like) may be created for subsequent variable importance factors to be gleaned and used for future decisions in pricing and growth determinations. As will be described below, a user may detect and determine influence of variable importance factors after index creation in order to modify the gain insight for future business decisions.

With having established an index, a server computer hosting the index may delineate the collected data into any manner of group level distinctions (indicators) such as by economic, geographic, or demographic groups at step 604. This categorized data may be further processed for analysis and modelling using steps 502-508 of FIG. 5 at step 606. Once prepared for modelling, the machine learning algorithm (350 of FIG. 5) may be used to glean variable importance factors from the assembled and processed data.

At step 608, a user may select specific predictors to model using the machine learning algorithm in order to determine which of the selected predictors result in the greatest influence on the overall index. The selected predictors (e.g., variable importance factors) may include data about weather, walkability, econometric trends, and the like for each specialty property identified with a lead or move-in. For example, one may wish to decipher data within the index about how much emphasis on costs or demands may be attributable to walkability. Thus, the walkability factor may have a decipherable weighting (e.g., a variable importance) that exhibits greater costs or demand for properties with a higher walkability factor of various specialty properties that are in the index. As another example, various properties having data corresponding to favorable weather may be weighted higher because of higher costs or demand exhibited for properties in favorable weather locations. In this manner, the user may tailor the gleaning of data from an index according to factors best suited toward the user's preference.

Within the context of the method of FIG. 6, a user may specify one or more variable importance factor to analyze at step 608. In order to provide a meaningful comparison between variable importance factors, typically two or more importance factors are chosen. Then, the method moves to step 610 where the assembled data groups (e.g., geographic delineations, economic delineations, and demographic delineations) are iteratively processed to fit simple regression models to predict the conditional mean and variance and their residuals, storing the best fitting predictor for each iteration. This is repeated M times for each predictor. Thus, at decision step 612, a first query determines if M times have been reached. If no, then the method steps right back to step 610 to fit another group of data in another iteration to determine which factor is the best fit amongst the initially selected set of variable importance factors. If M times have been reached, but the user wishes to select additional variable importance factors for a global comparison, the method shifts up to step 608 where a new set of variable importance factors are selected. Then the above-described set of M iterations is repeated at step 610. If the user wishes to finish the iterative process (e.g., no more variable importance factors to consider, then the method moves to step 614 where a count is established for each analyzed variable importance factor to determine the relative effect upon the assembled index data. From theses counts, the method may assign a weighting (e.g., variable importance) to each predictor at step 616. Such variable importance may be used to glean information about future decisions for cost setting and growth choices. The method ends at 618.

As data is gleaned from these analyses, a review of the assembled data will lead to determining specific variable importance factors that may be more important in terms of costs or demand. These variable importance factors may be used to decipher specific factors that have a greater influence on cost and demand. For example, if the cost data includes data about variables such as weather, state income tax, and walkability, one may determine among these three factors which has the greatest impact on cost. Additional variables may be analyzed as well. Together, each variable that is analyzed may be ranked in terms of impact (e.g., importance) of overall cost data or demand data.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments and does not pose a limitation to the scope of the disclosure unless otherwise claimed. No language in the specification should be construed as indicating any non-claimed element as essential to each embodiment of the present disclosure.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of this patent. Accordingly, the present subject matter is not limited to the embodiments described above or depicted in the drawings, and various embodiments and modifications can be made without departing from the scope of the claims below.

What is claimed is:

1. A computer-based method, comprising:
establishing an index for a plurality of specialty properties based on data about the plurality of specialty properties at a server computer;
delineating data into a plurality of groups based on one or more group identifiers;
identifying variable importance factors associated with the data in the index
iteratively generating a mean and variance for each group in the plurality of the groups for each of the one or more variable importance factors through a simple regression model fitting;
for each iteration, determining one variable importance factor that is the closest fit and incrementing a variable importance count for the best fitting variable importance factor; and
determining the variable importance factor having the highest variable importance count after all iterations.

2. The computer-based method of claim 1, further comprising:
assigning a weighting factor to each variable importance factor based on each variable importance count; and
modifying the established index according to each assigned weighting factor.

3. The computer-based method of claim 1, wherein generating index of data about the plurality of specialty properties comprises generating a cost index.

4. The computer-based method of claim 1, wherein generating index of data about the plurality of specialty properties comprises generating a demand index.

5. The computer-based method of claim 1, further comprising generating a first estimate of a future statistic about the plurality of specialty properties in response to one or more variable importance factors

6. The computer-based method of claim 1, further comprising communicating the assigned weighting factors to a remote computer.

7. The computer-based method of claim 1, wherein establishing an index for a plurality of specialty properties further comprises establishing an index for a plurality of assisted living specialty properties.

8. The computer-based method of claim 1, wherein establishing an index for a plurality of specialty properties further comprises establishing an index for a plurality of long-term care specialty properties.

9. The computer-based method of claim 1, wherein at least one variable importance factor comprises one of the group consisting of: a monetary budget, a geographic location, a care needs characterization, weather, walkability, social services, costs, proximity to amenities, amenities, and age of facility.

10. The computer-based method of claim 1, further comprising manipulating the data in the index for modelling prior to determining a best fit through simple regression.

11. A computer system, comprising:
a remote user computer coupled to a computer network and configured to collect data from a user about one or more specialty properties; and
a server computer coupled to the computer network and configured to:
establish an index for a plurality of specialty properties based on data about the plurality of specialty properties at a server computer;
delineate data into a plurality of groups based on one or more group identifiers;
identify variable importance factors associated with the data in the index
iteratively generate a mean and variance for each group in the plurality of the groups for each of the one or more variable importance factors through a simple regression model fitting;
for each iteration, determine one variable importance factor that is the closest fit and incrementing a variable importance count for the best fitting variable importance factor; and
determine the variable importance factor having the highest variable importance count after all iterations.

12. The computer system of claim 11, wherein the server computer is further configured to modify the established index in response to a weighting assigned to one or more variable importance factors.

13. The computer system of claim 11, wherein the server computer is further configured to generate a cost estimate in response to a weighting assigned to one or more variable importance factors.

14. The computer system of claim 11, wherein the server computer is further configured to generate a demand estimate in response to a weighting assigned to one or more variable importance factors.

15. The computer system of claim 11, wherein the server computer is further configured to communicate the assigned weighting factors to the remote user computer.

16. The computer system of claim 11, wherein the server computer is further configured to establish an index for a plurality of assisted living specialty properties.

17. The computer system of claim 11, wherein the server computer is further configured to establish an index for a plurality of long-term care specialty properties.

18. The computer system of claim 11, wherein at least one variable importance factor comprises one of the group consisting of: a monetary budget, a geographic location, a care needs characterization, weather, walkability, social services, costs, proximity to amenities, amenities, and age of facility.

19. The computer system of claim 11, wherein the server computer is further configured to:
receive input to manually adjust one or more weightings assigned to each variable importance factor; and
determine a third estimate using manually adjusted weighting factors.

20. The computer system of claim 11, wherein the server computer is further configured to discount at least one variable importance factor from influencing an estimate.
